(19) United States
(12) Patent Application Publication
(10) Pub. No.: US 2012/0161067 A1
(43) Pub. Date: Jun. 28, 2012

(54) DENTAL ETCHING GEL COMPOSITION AND METHOD OF USE THEREOF

(75) Inventors: Chih-Ta Lee, Taipei (TW); Ken-Yuan Chang, Taipei (TW)

(73) Assignee: FAR EASTERN NEW CENTURY CORPORATION

(21) Appl. No.: 12/976,264

(22) Filed: Dec. 22, 2010

(51) Int. Cl. C09K 13/06; C09K 13/08

(52) U.S. Cl. 252/79.3; 252/79.4

(57) ABSTRACT

The present invention provides a dental etching gel composition including phosphoric acid in aqueous solution form, a viscosity-enhancing agent and optionally additives, in which the viscosity-enhancing agent is carboxymethyl cellulose (CMC) with the following properties:
(a) having a viscosity of about 100 to about 2000 cps when formulated as an aqueous solution containing 1 wt % of CMC; and
(b) having an average degree of substitution of sodium salts in molecular formula of about 21% to about 33%.

The dental etching gel composition of the present invention can be used to pre-treat the surface of teeth prior to repair or filling. The etching gel formed by combining phosphoric acid in aqueous solution form with CMC viscosity-enhancing agent having the specific properties stated above is less fluid and thus can be used to etch the specific surface of the tooth so as to obtain a rough surface which improves the close adhesion between teeth and filling resins in the subsequent repairing or filling process.

### BACKGROUND OF THE INVENTION

1. Field of the Invention

The present invention relates to a novel dental etching gel composition, which can be widely used as an etching agent in a tooth repairing or filling process.

2. Description of the Prior Art

Using acrylic resins to fill dental caries is a method that is currently commonly used by dentists. Generally, the pre-treatment step prior to repair or filling is acid etching processing, that is, roughening of the surface of the tooth with phosphoric acid so as to remove or demineralize the stains on the surface of enamel or dentine of the tooth. The etching process can not only clean up the tiny stains on the surface of the tooth, but also decalcify the enamel of the tooth so as to form a rough surface on the tooth and thus generate a large surface area, which improves the close adhesion between filling materials and the tooth in the subsequent repairing or filling process.

Generally, the etching agent used in the etching process is phosphoric acid in aqueous solution form, and the concentration is mostly in the range of 10 to 40 wt %. Due to its high fluidity, when coated on the surface of the tooth, the etching agent flows freely, thereby causing the surface of healthy teeth to be etched and decalcified, and even damaging the surrounding tissues of the tooth. Therefore, an etching agent in gel form has been developed, which is referred to as an etching gel. The method for preparing the etching gel includes adding a viscosity-enhancing agent into phosphoric acid in aqueous solution form to make a gel, so as to eliminate the disadvantage of excessively high fluidity of phosphoric acid in aqueous solution form. The phosphoric acid thus formed is an etching gel, and can be directly coated on the specific surface of the tooth without flowing freely, thereby preventing healthy teeth from being etched and decalcified.

In early literature, silica is mainly used as the viscosity-enhancing agent (for example, U.S. Pat. Nos. 4,802,950, 6,537,563, and 6,753,001) to enhance the viscosity of phosphoric acid in aqueous solution form, and then filled into a 25 G (with a needle having an inner diameter of 0.25 mm) syringe, so as to conveniently and accurately dispose the phosphoric acid gel onto the correct position of the surface of the tooth. However, due to the poor water retention of silica, water in the phosphoric acid gel gradually evaporates with time. As a result, the concentration of phosphoric acid is increased, and the phosphoric acid gel may cause damage to the tooth and easily clog the needle, thereby resulting in considerable inconvenience in use.

In order to eliminate the disadvantage of silica as the viscosity-enhancing agent, molecules with good water retention are subsequently used as the viscosity-enhancing agent, such as glycerin (U.S. Pat. No. 5,954,996), sucralose (U.S. Pat. No. 6,689,343), and cellulose and derivatives thereof (U.S. Pat. Nos. 6,027,341 and 6,537,563). The most common cellulose-based viscosity-enhancing agent is carboxymethyl cellulose (CMC), which has good water absorption and retention properties, and thus is suitable for use as the viscosity-enhancing agent of phosphoric acid in aqueous solution form.

However, not all CMCs are suitable for preparation of the phosphoric acid etching gel. The inventors of the present invention found through studies that the viscosity and the average degree of substitution of sodium salts of CMC have a great effect on the final gel form of phosphoric acid in aqueous solution form, which has never been mentioned in literature. The intrinsic viscosity of CMC is related to the molecular weight and intermolecular force, and a high molecular weight easily causes entanglement of molecules, which increases the viscosity, resulting in poor fluidity when used to prepare the gel, and the gel may even clog the needle if the viscosity is higher, thereby resulting in inconvenience in operation. Moreover, when CMC is used to prepare the etching gel, CMC is in an acidic environment, and according to Le Chatelier's Principle, the higher the average degree of substitution of sodium salts of CMC, the lower the solubility in acidic aqueous solution. When the solubility is low, CMC cannot be uniformly dispersed in the phosphoric acid solution, and easily causes clogging of the needle when used, thereby making it inconvenient to use. Therefore, if CMC is used as the viscosity-enhancing agent to prepare the phosphoric acid etching gel, in order to effectively enhance the viscosity of phosphoric acid in aqueous solution form (without causing clogging of the needle in use) and maintain good water retention of the etching gel, the viscosity and the average degree of substitution of sodium salts of CMC are an important factor, which has never been mentioned in literature. U.S. Pat. No. 6,027,341 discloses that 1-5% of CMC can be added into an aqueous ethylenediamine tetraacetic acid (EDTA) solution to serve as a viscosity-enhancing agent. In U.S. Pat. No. 6,537,563, an acid gel etchant composition containing 10-50 wt % of phosphoric acid and about 3 to about 20 wt % of a colloidal silica sol is disclosed, which can optionally further contain 0.1-3 wt % of CMC as an organic viscosity-enhancing agent. In the two patents, the form of CMC is not described.

Therefore, the present invention mainly discloses a dental etching gel composition. The etching gel formed by combining phosphoric acid in aqueous solution form with CMC viscosity-enhancing agent having the specific properties is less fluid and has good water retention, and can be smoothly injected through a 25 G needle after being filled into a syringe without clogging the needle, and thus can be widely used as an etching agent in a tooth repairing or filling process.

### SUMMARY OF THE INVENTION

Accordingly, the present invention is directed to a dental etching gel composition which includes phosphoric acid in aqueous solution form and a viscosity-enhancing agent. The viscosity-enhancing agent is carboxymethyl cellulose (CMC) having the following properties:

(a) having a viscosity of about 100 to about 2000 cps when being formulated as an aqueous solution containing 1 wt % of CMC; and

(b) having an average degree of substitution of sodium salts in molecular formula of about 21% to about 33%.

The present invention is further directed to a method for increasing the surface roughness of tooth, which includes: prior to using filling resins, applying the dental etching gel composition of the present invention to the surface of a tooth for a suitable period of time so as to form a non-uniform surface, and removing the composition from the surface of the tooth with water.

### DETAILED DESCRIPTION OF THE INVENTION

The present invention mainly provides a dental etching gel composition containing phosphoric acid in aqueous solution form and a CMC viscosity-enhancing agent having specific properties, based upon the finding that in order to effectively enhance the viscosity of phosphoric acid in aqueous solution form (without causing clogging of the needle in use) and maintain good water retention of the etching gel, the viscosity and the average degree of substitution of sodium salts of CMC are an important factor.

According to an embodiment of the present invention, the concentration of phosphoric acid in aqueous solution form used in the dental etching gel composition as the main ingredient is 10 to 40 wt %, and preferably 37 wt %. The amount of phosphoric acid in the dental etching gel composition can effectively provide an etching effect on the surface of the tooth in 2 min, and preferably in 1 min. Generally, the effective amount of phosphoric acid can impart to the gel composition a pH value not higher than 1.

According to an embodiment of the present invention, the amount of CMC used in the dental etching gel composition as the viscosity-enhancing agent is preferably 0.5 to 7 wt %, more preferably 1 to 6 wt %, and most preferably 2 to 5 wt %, of the total weight of the composition.

CMC useful in the present invention as the viscosity-enhancing agent must have the following properties:

(a) having a viscosity of about 100 to about 2000 cps, preferably 300 to 1500 cps, when formulated as an aqueous solution containing 1 wt % of CMC; and

(b) having an average degree of substitution of sodium salts in molecular formula of about 21% to about 33%.

The definition of the average degree of substitution of sodium salts is given below.

If CMC and sodium salts thereof used as the viscosity-enhancing agent have structures of Formulae (I) and (II):

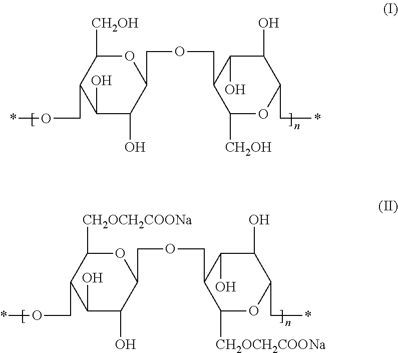

When n=10, that is, there are 600H functional groups, if H atoms of 13 functional groups are substituted by —CH₂COONa, the average degree of substitution of sodium salts in molecular formula of CMC is 21%, and the rest may be deduced by analogy.

As described above, the viscosity and the average degree of substitution of sodium salts of the CMC viscosity-enhancing agent are an important factor. When the viscosity of the CMC viscosity-enhancing agent is too high (excessively high degree of molecular entanglement) or the average degree of substitution of sodium salts in molecular formula is too high (decreased solubility in acidic environments), the resulting etching gel is too viscous, cannot be easily extruded from the syringe, easily clogs the needle, and is thus inconvenient in practical operation. In contrast, when the viscosity of the CMC viscosity-enhancing agent is too low or the average degree of substitution of sodium salts in molecular formula is too low, the resulting etching gel is too fluid and easily flows freely in practical use, causing damage to the surrounding tissues of the tooth.

As the dental etching gel composition of the present invention uses the CMC viscosity-enhancing agent having a viscosity and an average degree of substitution of sodium salts in molecular formula within particular ranges, it is of a semi-gel type. When filled into a syringe for application, the etching gel can be smoothly extruded without clogging the needle. Furthermore, when applied to the surface of the tooth, the etching gel can be fixed at a specific position and will not flow freely and cause damage to the surrounding tissues of the tooth. Herein, “semi-gel type” means that when the etching gel is filled into a 3 mL syringe and installed on the clamp of Instron and depressed at a constant speed of 2 mm/min, the extrusion force required for depressing the syringe is in the range of about 6 N to about 10 N.

The dental etching gel composition of the present invention can optionally further contain a color indicator. The main purpose of adding the color indicator is to distinguish the dental etching gel composition from the tooth, so that the tooth and the etching gel can be easily identified, and the etching gel can be removed completely after the etching process is completed. The commonly used color indicators are edible pigments, for example, but not limited to, methyl blue and methyl violet. Generally, commercially available products are mostly blue. The amount of the color indicator added is 0.0001 to 1.0 wt % of the total weight of the etching gel composition.

Moreover, the dental etching gel composition of the present invention can optionally further contain a flavor, so that in practical use, patients will smell the aroma instead of the sour odor of phosphoric acid. The commonly used flavors are edible flavors, for example, but not limited to, spearmint and fruit flavors. The amount of the flavor added is 0.0001 to 1.0 wt % of the total weight of the etching gel composition.

Besides the color indicator and the flavor, the dental etching gel composition of the present invention can further contain one or more other additives that are well known to persons of ordinary skill in the art and have no adverse effect on the composition of the present invention depending upon the requirements of practical applications, for example, a fluoride, a filler and/or an antibacterial agent.

The dental etching gel composition of the present invention does not clog the needle in practical applications and has the following features.

(a) The dental etching gel composition of the present invention can effectively remove tiny stains from the surface of the tooth and increase the roughness of the surface, thereby facilitating the adhesion between teeth and the repair or filling material.

(b) The dental etching gel composition of the present invention is of a semi-gel type and is less fluid, and can be fixed at a specific position for use.

(c) When filled into a syringe, the dental etching gel composition of the present invention can be easily extruded and distributed for use.

(d) The dental etching gel composition of the present invention can rapidly and effectively perform an etching effect on the surface of the tooth, and can be easily removed by rinsing with water after use.

Accordingly, the present invention further relates to a method for increasing surface roughness of teeth, which includes: prior to using filling resins, applying the dental etching gel composition of the present invention to the surface of a tooth for a suitable period of time so as to form a non-uniform surface, and removing the composition from the surface of the tooth with water. The actual application time can be deduced by persons of ordinary skill in the art, and generally is less than 1 min. Furthermore, the dental etching gel composition of the present invention can be applied to the surface of the tooth by using a syringe or other conventional methods.

The following embodiments are used to further describe the present invention, and do not limit the present invention. Any modifications and variations that can be easily made by persons of ordinary skill in the art fall within the scope of the disclosure of this specification and the appended claims.

### EXAMPLES

### Preparation of Dental Etching Gel

### Preparation Example 1

100 g of 37% phosphoric acid in aqueous solution form were formulated, into which 0.2 g of 1% methyl blue aqueous solution was added, and then 0.01 g of spearmint flavor was added. The resultant solution was placed in a container, and continuously stirred using a mixer with a Teflon stirring bar, and then 5 g of CMC (having a viscosity of 375 cps and an average degree of substitution of 27% at 1%; Aqualon (commercially available from Connell Bros. Co. (Taiwan) Ltd.)) were gradually added into the phosphoric acid solution, which was stirred uniformly to give a gel. The uniformly stirred phosphoric acid gel was centrifuged in a high-speed centrifuge, thus completing the preparation of the etching gel.

### Preparation Example 2

100 g of 37% phosphoric acid in aqueous solution form were formulated, into which 0.2 g of 1% methyl blue aqueous solution was added, and then 0.01 g of spearmint flavor was added. The resultant solution was placed in a container, and continuously stirred using a mixer with a Teflon stirring bar, and then 5 g of CMC (having a viscosity of 1500 cps and an average degree of substitution of 29% at 1%; Aqualon (commercially available from Connell Bros. Co. (Taiwan) Ltd.)) were gradually added into the phosphoric acid solution, which was stirred uniformly to give a gel. The uniformly stirred phosphoric acid gel was centrifuged in a high-speed centrifuge, thus completing the preparation of the etching gel.

### Comparative Example 1

100 g of 37% phosphoric acid in aqueous solution form were formulated, into which 0.2 g of 1% methyl blue aqueous solution was added, and then 0.01 g of spearmint flavor was added. The resultant solution was placed in a container, and continuously stirred using a mixer with a Teflon stirring bar, and then 5 g of CMC (having a viscosity of 50 cps and an average degree of substitution of 30% at 1%; Aqualon (commercially available from Connell Bros. Co. (Taiwan) Ltd.)) were gradually added into the phosphoric acid solution, which was stirred uniformly to give a gel. The uniformly stirred phosphoric acid gel was centrifuged in a high-speed centrifuge, thus completing the preparation of the etching gel.

### Comparative Example 2

100 g of 37% phosphoric acid in aqueous solution form were formulated, into which 0.2 g of 1% methyl blue aqueous solution was added, and then 0.01 g of spearmint flavor was added. The resultant solution was placed in a container, and continuously stirred using a mixer with a Teflon stirring bar, and then 5 g of CMC (having a viscosity of 3500 cps and an average degree of substitution of 25% at 1%; Aqualon (commercially available from Connell Bros. Co. (Taiwan) Ltd.)) were gradually added into the phosphoric acid solution, which was stirred uniformly to give a gel. The uniformly stirred phosphoric acid gel was centrifuged in a high-speed centrifuge, thus completing the preparation of the etching gel.

### Comparative Example 3

100 g of 37% phosphoric acid in aqueous solution form were formulated, into which 0.2 g of 1% methyl blue aqueous solution was added, and then 0.01 g of spearmint flavor was added. The resultant solution was placed in a container, and continuously stirred using a mixer with a Teflon stirring bar, and then 5 g of CMC (having a viscosity of 3500 cps and an average degree of substitution of 30% at 1%; Aqualon (commercially available from Connell Bros. Co. (Taiwan) Ltd.)) were gradually added into the phosphoric acid solution, which was stirred uniformly to give a gel. The uniformly stirred phosphoric acid gel was centrifuged in a high-speed centrifuge, thus completing the preparation of the etching gel.

### Comparative Example 4

100 g of 37% phosphoric acid in aqueous solution form were formulated, into which 0.2 g of 1% methyl blue aqueous solution was added, and then 0.01 g of spearmint flavor was added. The resultant solution was placed in a container, and continuously stirred using a mixer with a Teflon stirring bar, and then 5 g of CMC (having a viscosity of 400 cps and an average degree of substitution of 42% at 1%; Aqualon (commercially available from Connell Bros. Co. (Taiwan) Ltd.)) were gradually added into the phosphoric acid solution, which was stirred uniformly to give a gel. The uniformly stirred phosphoric acid gel was centrifuged in a high-speed centrifuge, thus completing the preparation of the etching gel.

### Comparative Example 5

100 g of 37% phosphoric acid in aqueous solution form were formulated, into which 0.2 g of 1% methyl blue aqueous solution was added, and then 0.01 g of spearmint flavor was added. The resultant solution was placed in a container, and continuously stirred using a mixer with a Teflon stirring bar, and then 5 g of CMC (having a viscosity of 1550 cps and an average degree of substitution of 36% at 1%; Aqualon (commercially available from Connell Bros. Co. (Taiwan) Ltd.)) were gradually added into the phosphoric acid solution, which was stirred uniformly to give a gel. The uniformly stirred phosphoric acid gel was centrifuged in a high-speed centrifuge, thus completing the preparation of the etching gel.

Viscosity Measurement

The CMCs used in Preparation Examples 1 to 2 and Comparative Examples 1 to 5 were formulated into 1 wt % aqueous solutions and fed into containers respectively, and the viscosity was measured on a Brookfield viscometer (HADV-III Ultra) using spindle #4. The results are shown in Table 1.

pH Value Measurement

The pH value of the etching gels prepared in Preparation Examples 1 to 2 and Comparative Examples 1 to 5 were measured using a pH/conductivity meter. The results are shown in Table 1.

Extrusion Force Measurement

The etching gels prepared in Preparation Examples 1 to 2 and Comparative Examples 1 to 5 were taken and filled into 3 mL syringes respectively, and installed on the clamp of Instron and depressed at a constant speed of 2 mm/min, so that the etching gel was extruded from the syringe stably, and the force required for depressing the syringe, i.e., the extrusion force, was observed. The results are shown in Table 1. The measurement value of the extrusion force must be lower than about 10 N to prevent the etching gel from clogging the needle in practical operation. Furthermore, the measurement value of the extrusion force must be higher than about 6 N, so that the etching gel is not so fluid as to cause damage to the surrounding tissues of the tooth of the patient in practical use.

TABLE 1

| | | CMC | | |
|---|---|---|---|---|
| | CMC | viscosity | | |
| | average degree of | (cps) | | Extrusion force |
| | substitution of | (in 1% | Gel | (Disperse by |
| | sodium salts (%) | solution) | pH | 25G needle) (N) |
| Preparation | 27 | 375 | <1 | 7.12 |
| Example 1 | | | | |
| Preparation | 29 | 1500 | <1 | 9.86 |
| Example 2 | | | | |
| Comparative | 30 | 50 | <1 | 5.35 |
| Example 1 | | | | |
| Comparative | 25 | 3500 | <1 | 15.25 |
| Example 2 | | | | |
| Comparative | 30 | 3500 | <1 | 19.14 |
| Example 3 | | | | |
| Comparative | 42 | 400 | <1 | 10.57 |
| Example 4 | | | | |
| Comparative | 36 | 1550 | <1 | 13.43 |
| Example 5 | | | | |

It can be seen from the experimental results of Preparation Example 2 and Comparative Example 3 that, when the average degree of substitution of sodium salts is similar, when the viscosity increases (at the same concentration, the higher the viscosity, the higher the molecular weight), the degree of molecular entanglement of the etching gel is increased. Therefore, in practical use, the etching gel cannot be easily extruded, and will easily clog the needle. On the other hand, as can be seen from the experimental results of Preparation Example 2 and Comparative Example 1, when the average degree of substitution of sodium salts is the same, the lower the viscosity, the lower the degree of molecular entanglement, and the higher the fluidity, under which circumstances the etching gel will easily cause damage to the surrounding tissues of the tooth of the patient in practical use.

Moreover, it can be known by comparing Preparation Example 1 with Comparative Example 4 and Preparation Example 2 with Comparative Example 5 that, at the same concentration, when the groups of molecules have similar viscosity (similar molecular weight), after the gel is formed, since CMC is in an acidic environment, the higher the average degree of substitution of sodium salts in molecular formula of CMC, the lower the solubility, so the etching gel cannot be easily extruded after being filled into the syringe, and will easily clog the needle, thereby making it inconvenient to use in practical operation.

It will be appreciated that various improvements of the present invention are feasible and can be easily thought of and anticipated by persons skilled in the art.

1. A dental etching gel composition, comprising phosphoric acid in aqueous solution form and a viscosity-enhancing agent, wherein the viscosity-enhancing agent is carboxymethyl cellulose (CMC) having the following properties:
(a) having a viscosity of about 100 to about 2000 cps when formulated as an aqueous solution comprising 1 wt % of CMC; and
(b) having an average degree of substitution of sodium salts in molecular formula of about 21% to about 33%.

2. The dental etching gel composition according to claim 1, wherein the concentration of the phosphoric acid in aqueous solution form is 10 to 40 wt %.

3. The dental etching gel composition according to claim 2, wherein the concentration of the phosphoric acid in aqueous solution form is 37 wt %.

4. The dental etching gel composition according to claim 1, wherein CMC is present in an amount of 0.5 to 7 wt % of the total weight of the etching gel composition.

5. The dental etching gel composition according to claim 4, wherein CMC is present in an amount of 1 to 6 wt % of the total weight of the etching gel composition.

6. The dental etching gel composition according to claim 5, wherein CMC is present in an amount of 2 to 5 wt % of the total weight of the etching gel composition.

7. The dental etching gel composition according to claim 1, wherein CMC has the following properties:
(a) having a viscosity of about 300 to about 1500 cps when formulated as an aqueous solution comprising 1 wt % of CMC; and
(b) having an average degree of substitution of sodium salts in molecular formula of about 21% to about 33%.

8. The dental etching gel composition according to claim 1, further comprising one or more additives selected from the group consisting of a color indicator, a flavor, a fluoride, a filler and an antibacterial agent.

9. The dental etching gel composition according to claim 8, wherein the color indicator is methyl blue and the flavor is spearmint.

10. The dental etching gel composition according to claim 9, wherein the color indicator is present in an amount of 0.0001 to 1.0 wt % of the total weight of the etching gel composition.

11. The dental etching gel composition according to claim 9, wherein the flavor is present in an amount of 0.0001 to 1.0 wt % of the total weight of the dental etching gel composition.

12. A method for increasing surface roughness of teeth, comprising, prior to using filling resins, applying the dental etching gel composition according to claim 1 to the surface of a tooth for a suitable period of time so as to form a non-uniform surface, and removing the composition from the surface of the tooth with water.
